(19) United States
(12) Patent Application Publication
(10) Pub. No.: US 2006/0279815 A1
(43) Pub. Date: Dec. 14, 2006

(54) Holographic real-time projection

(76) Inventors: Spencer A. Rathus, New York, NY (US); Juliene P. Britt, New York, NY (US)

Correspondence Address: Ward & Olivo, 382 Springfield Avenue, Suite 410, Summit, NJ, 07901, US

(21) Appl. No.: 11/149,842

(22) Filed: Jun. 10, 2005

(51) Int. Cl. G03H 1/00

(52) U.S. Cl. 359/1

(57) ABSTRACT

The disclosed methods and apparatus relate generally to the field of communication, the media industries, and the visual arts. More specifically, they pertain to the recording, processing, transmission, and real-time projection of holographic images for purposes such as communication, entertainment, education, and decoration. The information stored within the interference pattern is digitized and transmitted through a plurality of devices or data connections to a projection box. The box processes the information and the resultant imagery can be viewed as free standing, on a thin screen, or by other means current in the art.

### FIELD OF INVENTION

The disclosed methods and apparatus relate generally to the fields of communication, media, and the visual arts. More specifically, they pertain to the recording, processing, transmission, and projection of holographic images for purposes of communication, entertainment, education, decoration, and the like.

### BACKROUND

There are many different types of holograms. The most intricate and realistic holograms are taken from the production of numerous reference beam angles. Multiple beam splitters split the reference beam that illuminate the imaged object, thus producing more interference of waves between the object beam waves and the reference beam waves. FIG. 1 (prior art) shows a basic reflective-type hologram set-up.

The most common laser used for holographic recording is the HeNe, helium neon laser, which is relatively inexpensive in comparison to other lasers. Other types of lasers can produce clearer results, depending on their levels of intensity and stability of their beams. The more coherent or in phase the light, the clearer the interference pattern (or diffraction grating) will be when the beams interact.

Light is used in producing holograms of three-dimensional (3-D) objects or 3-D scenes to record data in the form of interference patterns. When subsequently re-illuminated, these patterns provide the 3-D image of the recorded object or scene. The re-illumination process reconstructs the intensity field. The information is stored and can be described in basic electric field functions of the reference beam and object beam. These functions can be derived from or according to their basic irradiance distribution functions. These two functions are represented, respectively, in FIG. 2A and FIG. 2B. When the fields of the object (holographic image) beam and reference (laser) beam interfere, a pattern is recorded onto a high-resolution medium, such as film.

The interference of the beams causes both constructive and destructive interferences, depending on whether the crests of the wave interact, or the crest and trough of the wave interact. These interactions essentially “burn” the fringe pattern into the film, which will later be used to create the hologram. IBM has developed methods to capture the beam information on a computer in order to encode the interference pattern in the form of Fourier series.

An important aspect of holography is that all the information concerning the image is stored in every piece of film. For example, if a holographic image is recorded onto a 2 inch by 2 inch piece of film or frame, and a small 1 centimeter by 1 centimeter piece is taken from the top right corner of the frame, the smaller piece of film will produce the same hologram as the larger, original frame when it is illuminated again by the laser. However, every part of the original frame represents a different angle from which the holographic image was recorded, so the image seen through the smaller piece of film would be from a different angular vantage point. This characteristic of a hologram can be advantageously applied in the present invention. Because each piece of the film records all different angles from which the object or scene is viewed, the viewer can walk back and forth in front of the reconstructed image to see it from all angles, just as if the object or scene were present. However, if the viewer were to seek a vantage point beyond a certain angle (e.g. 100 degrees) the projected image would begin to vanish.

Commercialization of holography is evident in a plurality of public media. Holographic stickers are sold in stores. Many credit cards, ID badges, CD's, and the like use embossed holograms. In Hollywood, a recent use of a hologram-type image utilized an essentially falsified hologram. A transparent screen is used as a vehicle onto which to project pre-recorded information. The image appears to be floating and free-standing when viewed by an audience. However, this is not the case. These types of real-life-size holograms can also be seen in museums, theme parks (as ghosts in haunted houses), and in casinos.

Holography also has scientific uses. For example, it is used in astronomy to image stars and galaxies. In acoustics, holography images vibrations created by the sound of a musical instrument or other object. Multiple holographic images are recorded and superimposed in order to make the image 3-D.

Although many types of holograms have been produced, the prior art is limited in scope. The majority of the prior art utilizes a holographic projection screen for projection of images or video segments. These screens essentially divide the light projected onto them, and remove spectral scattering to produce a more clearly defined image. Other examples of prior art create an image by using holographic optical elements (HOES) such as diffusers or collimators. Still other methods use HOES simply to manipulate the light that is propagating toward a projector.

Holographic images are only seen on the opposite viewing side of a holographic film, and therefore would not appear “real” to the viewer. However, there is a plurality of existing means for projecting highly realistic holographic images. Prior art by Intel provide methods for storage cells that store the interference patterns of the image, but this method produces only one stagnant image per cell. Some companies use a series of recorded “strips” of imaging in order to achieve different angular perspectives of the entire image on shutter intervals, which provides a seemingly rotational aspect to the image. Companies such as Fujitsu Limited provide methods and apparatuses for use of a similar recording technique on material that periodically moves in order to record multiple images. These and similar techniques can provide a multipoint holographic image; however, they fall short of providing real-time transmission of the image.

Two 3-D television sets were displayed as “Future” technology at the Consumer Electronics Show in Las Vegas, Jan. 6-Jan. 9, 2005. The televisions were presented by the Korean firm LG Electronics (a subsidiary of LG Corp.). Neither set used holograms. One television set showed the familiar stereoscopic 3-D imagery that requires special glasses to perceive. This method has been in use since at least 1953, when it was shown in the original Hollywood film “House of Wax.” Theatergoers were given the glasses as they entered the theater and asked to drop them off on the way out. The second television set showed 3-D “auto-stereoscopic” imagery on an LCD monitor, which can be perceived with the naked eye; that is, it does not required the colored glasses.

A key disadvantage of the first method is the requirement that the viewer use the special glasses; otherwise the eye cannot focus the imagery at all. A key disadvantage of the second method is that the viewer needs to view the screen from a certain distance and angle, and loses the 3-D effect by moving forward, backward, or to the side. (The floor of the convention was marked with the “sweet spot” where the viewer needed to stand in order to perceive the 3-D effect.) Therefore, the viewer is rooted to one position, and a plurality of viewers cannot observe the 3-D effect at the same time. Advantages of the present invention include the facts that (a) no special glasses or other viewing devices are required, and (b) viewers can obtain the 3-D effect of the imagery from various distances and viewing angles. In fact, in the present invention, moving to the side or up or down will enhance the experience by allowing the viewer to observe the imagery from different perspectives, as in real life. A viewer can even replay a scene in order to appreciate it from another perspective.

### SUMMARY OF THE INVENTION

The present invention is a system for transmitting a continuous stream of real-time holographic images. The system utilizes one or more light sources, preferably in the form of lasers, to record holographic images of an object and/or scene. Recording is performed within a small, enclosed first device that holds a holographic set-up. Once the images are recorded, they are transferred via a wireless connection, or a hard-wired connection, to another small, enclosed device that is similar to the first device wherein the image was recorded. The receiving second device provides a light source similar to that used in the recording of the images to produce and project a continuous stream of real-time holographic images of the object and/or scene recorded at the location of origin.

Because holographic information involves visual images, a means of recording and transmitting sound can also be incorporated into the system and—as one possibility—associated with the imaging box. These means might involve a voice recorder and transmitter, a telephone line connection, and/or a VoIP connection. Both the visual image signal and the voice signal are processed by the box and transmitted via a wireless or hard-wired connection to a speaker system which is placed within the room, or within the imaging box itself.

The imaging box contains a processing unit, a short-term/re-writeable memory unit, and the holographic set-up or apparatus. There might be multiple holographic set-ups within the box to create and project a more defined and extensive holographic image or a continuous stream of images.

The holographic image is recorded on a plane where the object beams, reflected off the person, and the reference beams interfere. The final hologram image is recorded in the form of an electric field as can be represented mathematically in FIG. 2C. Electric field data is transferred via a digital signaling method to the box located where the imagery is to be projected. Projection can be accomplished via a plurality of means, which will be further disclosed in the detailed description.

### BRIEF DESCRIPTION OF THE DRAWINGS

A further understanding of the present invention can be obtained by reference to a preferred embodiment as set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the specific methods and instrumentalities disclosed.

For a more complete understanding of the present invention, reference is now made to the following drawings in which:

FIG. 1: Shows a basic reflective-type hologram set-up displaying the beam path of both the reference beam and the object beam and the plane where the holographic image is recorded in the form of interference patterns.

FIG. 2A: Gives the mathematical representation of the total electric field, which is comprised of the electric field of both the reference and object beams.

FIG. 2B: Provides the mathematical representation of the total irradiance distribution, or diffraction pattern, which is a function of the electric fields of the reference and object beams and their path-lengths.

FIG. 2C: Gives the mathematical representation of the actual hologram that is resultant after re-illumination of the recorded data, in the form of an electrical field.

FIG. 3: Shows an open view of possible contents and set-up within the imaging box.

FIG. 4: Depicts the general process of operation of the present invention.

FIG. 5: Provides an exemplary situation in which the system is used in cinematography.

FIG. 6: Provides an exemplary situation in which the system is used for a conference wherein the person speaking is not actually located within the same room as those whom are listening to him or her.

### DETAILED DESCRIPTION OF THE INVENTION

The Hologram

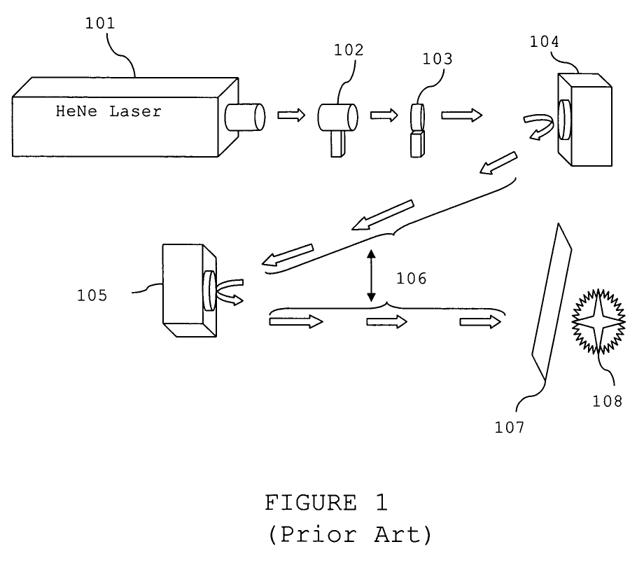

As disclosed within the background, a hologram can be made by a plurality of methods and apparatuses. These systems determine the quality and type of hologram. The present invention records or constructs the hologram within the imaging box. Referring now to FIG. 1, the present invention utilizes a well known hologram system 100. The hologram system comprises a laser source 101, various mirrors 104 and 105, and can further comprise beam splitters 103 and other lenses 102. The laser source 101 generates a laser beam 106 that travels through the system and is targeted to any object. The laser beam strikes a target 107 and generates a hologram 108 in a manner well known in the art. Of course, the aforementioned system is merely representative in the present invention. It is contemplated that any other well known hologram generating means can be used to generate the hologram. In a preferred embodiment, the hologram is generated by a HeNe laser.

In a preferred emobdiment, when laser source 101 is activated, the set-up begins to produce an electric field of data necessary to reproduce the object in holographic form. The hologram 108 is recorded onto a high-resolution film that is spooled in order to gather continuous field changes from movement of the object or objects to be recorded.

Current methods of filmmaking and film projection are able to produce new images approximately every 22^{nd} to 24^{th} of a second (that is, they show about 22 to 24 frames per second), whereas the method described herein potentially produces new images every 10⁻¹⁹ of a second. That is, the method and apparatus produce images in less than a trillionth of a second. In terms of the human sensorial and perceptual processes, such images appear to be continuous or seamless.

When the information is transmitted into another, or second, similar set-up, the fields are recorded onto a high-resolution film or manipulated by their numerical representation. They are re-illuminated to produce the exact object or objects in the form of a hologram. The hologram maintains its resolution when placed on a larger screen because it is produced by monochromatic light. Initially, the hologram is always reproduced at the same size at which it is recorded. However, as is possible with many optical set-ups, additional lenses can magnify the image.

Transmission of the Hologram

When a hologram is produced, the image is described by two sets of a series of equations. These equations represent the electric fields surrounding the original light beam that is produced by (1) the laser, which is referred to as the reference beam 201, and (2) the reflected light beams from the object (object beam 202), which is produced when the reference beam illuminates the object or objects. The second set of equations relies on the irradiance distribution created by these electric fields. The first 204 is a combination of the electric fields produced by the reference beam and object beam multiplied by the combination of the conjugates of the two fields. The second equation 205 is an expanded form of the primary equation 204; the third equation 206 is a further expansion of the second 205 equation. The last equation indicates how the fringe pattern is produced from constructive and destructive interference. For instance, if the exponential components match angles (α, β), complete constructive interference occurs and the irradiance distribution consists only of components r², o², and 2os; thus, the highest beam (light) intensity is achieved. As the angles vary, so do the intensities of the beams, and the irradiance distribution is generated. The final output electric field of the hologram is a function of the both the irradiance distribution and the addition, or total, electric field of the reference and object beams. The resultant electric field 207 is formed and recorded onto the high-resolution film 107 in the set-up.

These numbers can all be calculated, and the information derived thereby is transferable as numerical data. The mathematical representation of the data is retrieved via a processor component. The component saves, writes, or performs any other desired function with the acquired mathematical representation of the hologram.

The Imaging Box

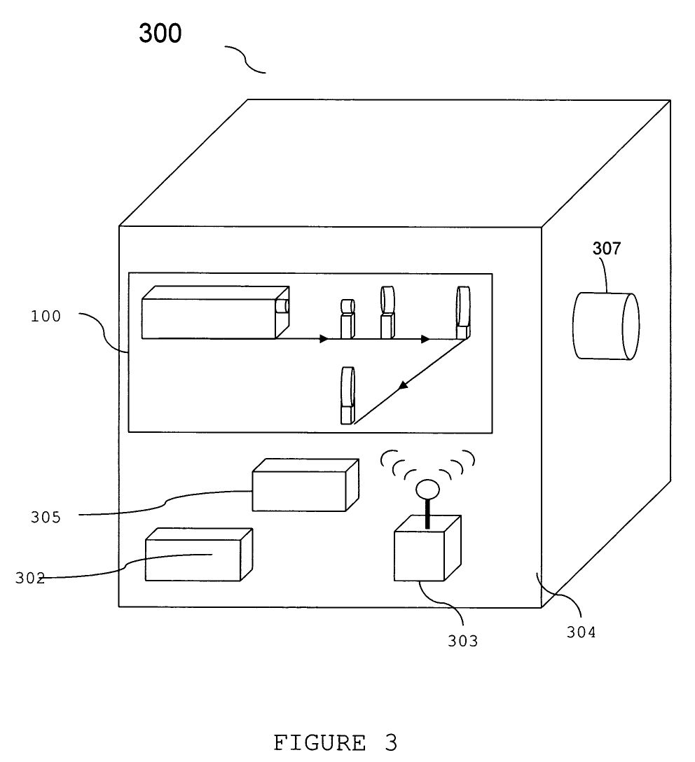

Referring now to FIG. 3, the imaging boxes 300 can contain many different sets of components, dependent on the desired product. The necessary components for each box are a cover 304, base 301, transmitting device 302, a holographic set-up 100, a projection component 307, and a processing unit 305. The holographic set-up 100 requires a laser and mirrors. Additional components such as objectives, lenses, beam-splitters, and the like can be included, dependent on the type and quality of the hologram. The projection component 307 requires basic parts that are common in the art. As well, the cover 303 and base 304 protect the internal components and need to be made of a hard material such as plastic, “extreme textile,” or metal.

The imaging boxes might also contain multiple holographic set-ups. Essentially, the multiple set-ups provide a variety of angular perspectives not only when recording the image, but also at a variety of depths. These depths may be achieved in two ways. One is to use multiple boxes placed at different points around the object to be recorded. The second is to place the holographic set-ups at different distances from the front of the imaging box so that they can create a foreground, middle ground, and background in the imagery. The image is recorded and transmitted in sequences from each device. For example, if there were three set-ups within the box, the sequence would take an image shot from set-up 1, then from set-up 2, and then from set-up 3. These sequences are perceptually seamless because pulse lengths can be recorded in femtoseconds. That is, the processes of human sensation and perception perceive them as a continuous stream of visual imagery, as is movement in “real life.”

The Transmitting Device

Referring back to FIG. 3, the transmitting device 302 comprises a chip component, or the like, that is used with a common landline wire 303. The only requirements are that the device can transmit and receive a signal. A plurality of additional components can be combined with the transmitter depending on the condition, or type of signal, to be transmitted. For instance, there can be modulators, converters, compressors, or the like. The connection is preferably a high-speed Internet connection that allows continuous streaming of large amounts of data in a digital format. However, slower connections and analog signals can also carry out this function. The machine is also shown as having a wireless component that communicates with a plurality of wireless devices. The signal can be streamed through a cellular telephone, a PDA, a laptop computer, or the like. The user provides the means to open a connection between the first and second imaging boxes.

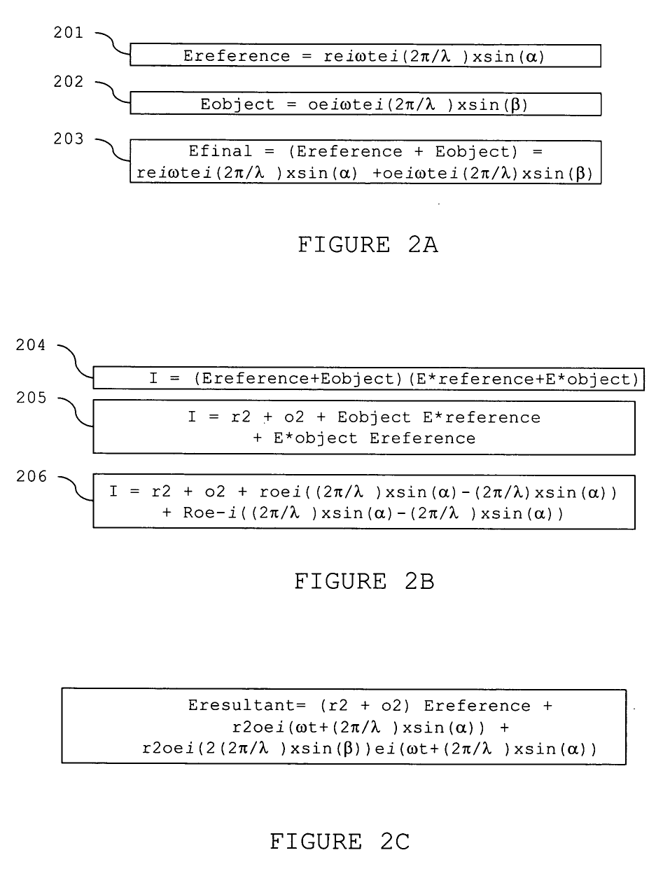

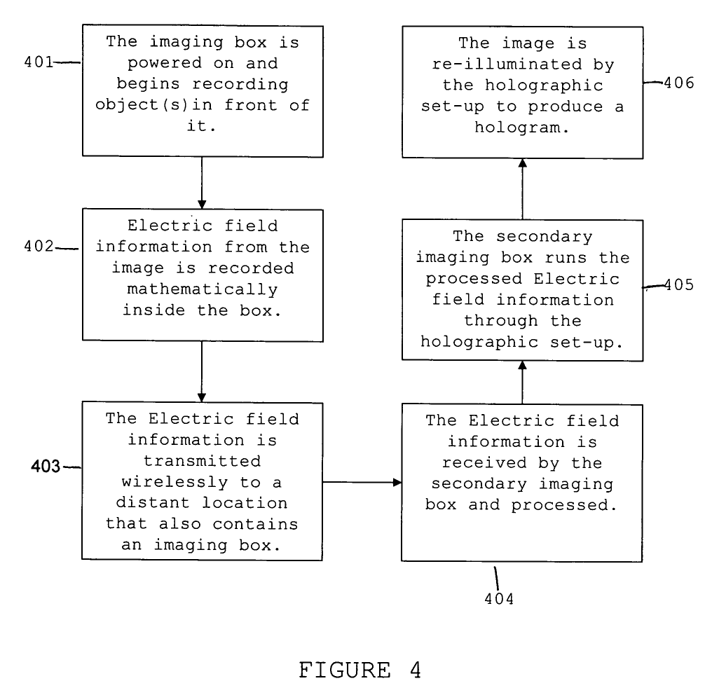

Referring to FIG. 4, disclosed is the general operation of the current invention. When an imaging box is activated, it begins to record a targeted object 401. The imaging box records the data related to the electric field generated and converts this data into mathematical data as depicted in step 402. In a preferred embodiment, the data is converted using the equations described in FIGS. 2A-C.

The converted data is then transmitted and to a second device, which is preferably another imaging box as depicted in steps 403 and 404. It is contemplated that the data can travel over any distance using a variety of data transmission sources, including but not limited to: the Internet, the World Wide Web, a computer network, an integrated service digital network (ISDN), a telephone line a cable television CATV line a local area network, a wide area network, a data communications network, a globally based digital communications network, a wireless network link, a Wireless Application Protocol Internet, an Ethernet network, and a radio frequency (RF) cellular network.

The second imaging box processes the electric field data and operates the linked holographic set up 405. Any well known processing means and linking means can be used. In addition, the processing means can be linked to any means of making a hologram. In a preferred embodiment, the hologram is created by a HeNe laser.

After the data is processed and linked to the hologram set up, the hologram set up produces the final image 406. Depending on the speed of the data transmission, a viewer can view a three dimensional hologram of the streaming data.

Additional Embodiments

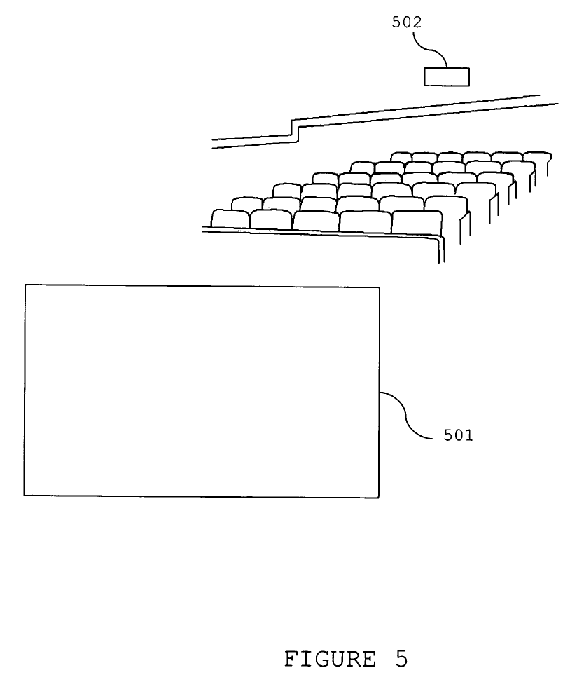

The present invention also can be used in the film industry. Scenes are performed in front of the imaging box, or multiple imaging boxes, and are recorded onto film. As depicted in FIG. 5, the film is later projected onto a screen 501 at a location in movie theater 500 viewed at the theater or other venue through an imaging box or similar device with analogous functionality located at an displaying site 502. The viewers experience a new and visually exceptional form of cinematography.

Similarly, the present invention can be used in the television industry. This embodiment requires the imaging box and a thin film screen for viewing. The television stations are able to wirelessly, or through landline, transmit signals to the box. The signal used depends on the user's service provider, for example, digital cable, satellite, or the like.

Yet another embodiment is use of the method and apparatus within museums and galleries. Museums can access holographic imagery of any works of art and display them in a format that is virtually indistinguishable from the original. This embodiment provides non-travelers the opportunity to view works by great masters from all periods of art and all cultures in a format in which they can be fully appreciated. For instance, much artwork utilizes texture and size to add effect-features that are preserved in a hologram. Similarly, works of art can be brought into classrooms or residences. Every home can boast a Van Gogh landscape, with its thick impasto visually elevated from the surface and all brushstrokes highly visible. Every schoolroom can have Michelangelo's captured slave struggling to break free from encasing marble.

Still another embodiment recognizes that most holograms produced are visually distinguishable from the original image. In this embodiment, therefore, digitally re-mastering an image to clarify its colors and form, as is currently being practiced, can be applied to holographic images that are transmitted in a continuous stream, heightening the realistic qualities of the image that is projected by the receiving imaging box. Therefore, the artwork in the museums as well as all the aforementioned embodiments can be viewed as clearly as the original object that was imaged. This method and apparatus carries significant importance in the realm of 3-D art, such as sculpture and craft objects. People are able to walk around them to some degree with the image remaining intact. However, if viewers move too far, exceeding the operating range of the angles of the vantage points, the image will begin to vanish.

Yet another embodiment recognizes that the so-called imaging box is a convenience, and that the methods and apparatus for recording holographic images, processing them, re-mastering them, storing them, transmitting them, receiving them, projecting them, and associating them with audio images (sound) can be embodied in a plurality of devices, each of which carries out one or more of the above-mentioned functions. These devices also can take on a variety of shapes, sizes, colors, and so on. It is the intention of the present invention to provide a means for recording holographic images, a means for storing holographic images, a means for re-mastering holographic images, a means for transmitting (streaming) them to a receiving device, and a means for processing them and projecting them once received. The exact physical embodiment of this plurality of means is not limited to two “boxes” and a method for transmitting information from one to the other. Moreover, a variety of configurations is possible. For example, a re-mastering means might have a separate physical embodiment, whereas a means for recording and storing holographic images is situated within a single overall housing. Alternatively, the means for storing the holographic images can be housed in a remote server or network of servers and/or a personal computer.

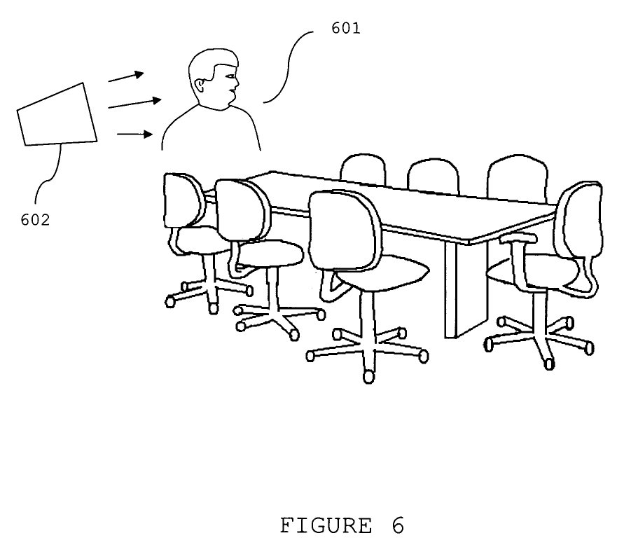

FIG. 6 depicts an example of a conference of participants in a plurality of locations. In the first conference room (not shown), a person makes a speech in front of the first imaging box. The imaging box is activated and begins to record images of the person making the speech. The box can have both wireless and hard-wired capabilities to transmit and receive information as well as connection ports to the Internet and/or phone lines.

In a second conference room 600, which may be thousands of miles away, another, second, imaging box 602 is activated to receive a continuous stream of holographic data images of the speechmaker in the first conference room. The data images can be transferred via a plurality of devices, such as a cellular telephone, a PDA, an Internet connection, or the like. Upon receiving the signals that contain the data representative of the images, the second imaging box processes them through a holographic apparatus that mirrors the set-up in the first box. Following processing, the second imaging box projects a holographic image 601 of the speechmaker, along with those features of his or her setting that were in the range of the recording device.

What is claimed is:

1. A system for the real-time recording, transmission, and display of a stream of holographic images, the system comprising:
a) at least one holographic set-up in a first location;
b) at least one processing chip in said first location that gathers the electric field data pertaining to the hologram created by said holographic set-up, encodes it, and sends it to a transmitter in a coded format;
c) a transmitting component that transmits the coded data to at least one other location that also has at least one holographic set-up;
d) a receiving component in said at least one other location that receives said coded data and supplies it to at least one processing chip; and
e) at least one holographic set-up in said at least one other location;
wherein said stream of holographic images is recorded at said first location; said at least one processing chip in said first location gathers said electric field data pertaining to said stream of holographic images and sends it to said transmitter in said coded format; whereupon receiving said electric field data, said transmitting component transmits said coded data to at least one other location; wherein a receiving component in said at least one other location receives said coded data and supplies it to said at least one processing chip; wherein said processing chip decodes said coded data and supplies said decoded data to at least one holographic set-up in said at least one other location; and whereupon receiving said decoded data from said processing chip, said holographic set-up projects said stream of holographic images in humanly perceptible form.

2. The system in claim 1 wherein said at least one holographic set-up and said at least one processing chip are housed together in an imaging box.

3. The system in claim 1 wherein said transmission of said coded data is transmitted via a data link.

4. The system in claim 3 wherein said data link comprises an information superhighway data link.

5. The system in claim 4 wherein said information superhighway data link is at least one selected from the group consisting of the Internet, the World Wide Web, a computer network, an integrated service digital network (ISDN), a telephone line a cable television CATV line a local area network, a wide area network, a data communications network, a globally based digital communications network, a wireless network link, a Wireless Application Protocol Internet, an Ethernet network, and a radio frequency (RF) cellular network.

6. The system of claim 1 wherein said holographic set-ups further comprise at least one selected from the group consisting of a laser, mirrors, lenses, and a beam-splitter.

7. The system of claim 1 wherein multiple holographic set-ups at each location permit the simultaneous transmission and reception of coded electric field data.

8. The system of claim 1 wherein said coded data comprises digital data.

9. The system of claim 1 wherein said coded data comprises analog data.

10. The system if claim 1 wherein said at least one processing unit can compress electric field data.

11. The system of claim 1 wherein said electric field data is re-mastered before it is transmitted.

12. The system of claim 1 wherein said electric field data is re-mastered after it is received but before it is displayed.

13. The system of claim 1 wherein said at least one processing unit records electric field data.

14. The system of claim 13 wherein said recorded data is stored in a storage unit.

15. The system of claim 14 wherein said storage unit comprises a remote server.

16. The system of claim 14 where at least one user of the system can download said recorded data and project it using his or her at least one holographic set-up.

17. The system of claim 16 wherein the account of said at least one user of the system is charged a fee for downloading said recorded data.

18. The system of claim 16 wherein said at least one user of the system can download said recorded data, store it, and project it when desired.

19. A system for the recording, transmission, and display of a stream of holographic images, the system comprising:
a) at least one holographic set-up in a first location;
b) at least one processing chip in said first location that gathers the electric field data pertaining to the hologram created by said holographic set-up and encodes it;
c) a memory means to store a record of said encoded electric field data;
d) a means for retrieving said encoded electric field data;
e) a means for sending said encoded electric field data to a transmitter;
f) a transmitting component that transmits said encoded data to at least one other location;
g) a receiving component in said at least one other location that receives said encoded data and supplies it to at least one processing chip; and
h) at least one holographic set-up in said at least one other location;
wherein said stream of holographic images is recorded in said first location; said memory means is used to store said record of said encoded electric field data; said record of said encoded electric field data is retrieved and sent to said transmitter; said transmitting component transmits said record of said encoded electric field data to at least one other location; said processing chip in said at least one other location decodes said encoded electric field data and supplies said decoded data to at least one holographic set-up; and whereupon receiving said decoded data, said holographic set-up projects said decoded data in humanly perceptible form.

20. The system of claim 19 wherein said film comprises high-resolution film.

21. The system in claim 19 wherein said at least one holographic set-up and said at least one processing chip are housed together in an imaging box.

22. The system in claim 19 wherein said transmission of said coded data is transmitted via a data link.

23. The system in claim 22 wherein said data link comprises an information superhighway data link.

24. The system in claim 23 wherein said information superhighway data link is at least one selected from the group consisting of the Internet, the World Wide Web, a computer network, an integrated service digital network (ISDN), a telephone line a cable television CATV line a local area network, a wide area network, a data communications network, a globally based digital communications network, a wireless network link, a Wireless Application Protocol Internet, an Ethernet network, and a radio frequency (RF) cellular network.

25. The system of claim 19 wherein said holographic set-ups further comprise at least one selected from the group consisting of a laser, mirrors, lenses, and a beam-splitter.

26. The system of claim 19 wherein multiple holographic set-ups at each location permit the simultaneous transmission and reception of coded electric field data.

27. The system of claim 19 wherein said coded data comprises digital data.

28. The system of claim 19 wherein said coded data comprises analog data.

29. The system if claim 19 wherein said at least one processing unit can compress electric field data.

30. The system of claim 19 wherein said electric field data is re-mastered before it is transmitted.

31. The system of claim 19 wherein said electric field data is re-mastered after it is received but before it is displayed.

32. The system of claim 19 wherein said at least one processing unit records electric field data.

33. The system of claim 32 wherein said recorded data is stored in a storage unit.

34. The system of claim 33 wherein said storage unit comprises a remote server.

35. The system of claim 33 where at least one user of the system can download said recorded data and project it using his or her at least one holographic set-up.

36. The system of claim 35 wherein the account of said at least one user of the system is charged a fee for downloading said recorded data.

37. The system of claim 35 wherein said at least one user of the system can download said recorded data, store it, and project it when desired.

38. A system for the recording, transmission, and display of a holographic image, the system comprising:
a) at least one holographic set-up in a first location;
b) at least one processing chip in said first location that gathers the electric field data pertaining to the hologram created by said holographic set-up and encodes it;
c) a means for sending said encoded electric field data to a transmitter;
d) a transmitting component that transmits said encoded data to at least one other location;
e) a receiving component in said at least one other location that receives said encoded data and supplies it to at least one processing chip; and
f) at least one holographic set-up in said at least one other location;
wherein said holographic image is recorded in said first location; said image is encoded by said processing chip; said encoded image is sent to a transmitter and, from there, to at least one other location; said processing chip in said at least one other location decodes said encoded image and supplies said decoded image to at least one holographic set-up, which projects said holographic image in humanly perceptible form.
